(19) United States
(12) Patent Application Publication
(10) Pub. No.: US 2008/0224843 A1
(43) Pub. Date: Sep. 18, 2008

(54) LED Signal System for Truck

(75) Inventor: EUGENE RUSSELL OVERLINE, GILBERT, AZ (US)

Correspondence Address: EUGENE OVERLINE, PO BOX 2564, GILBERT, AZ, 85299, US

(73) Assignee: EUGENE RUSSELL OVERLINE, GILBERT, AZ (US)

(21) Appl. No.: 11/686,792

(22) Filed: Mar. 15, 2007

(51) Int. Cl. B60Q 1/22

(52) U.S. Cl. 340/463

(57) ABSTRACT

An LED Signal System most specifically designed for mounting on the underside of the tailgate of a truck in the space between the tailgate and the bumper. A plurality of LED lamps indicate the reverse light function of the truck. The lamps are sized such that they fit below the tailgate without impeding operation of the tailgate opening.

### BACKGROUND OF THE INVENTION

1. Field of the Invention

This invention relates to vehicle accessories. More particularly, this invention relates to a lighting system for mounting at the base of or under the tailgate of a truck or similar vehicle that provides reverse light indicators using a plurality of LED Lamps.

2. Background Art

The customization of trucks and truck ownership has increased substantially in recent years. Although trucks have an obvious utility for carrying loads, they are also becoming very popular to personalize and reflect the personality of the driver. Truck owners continually look for ways to personalize the appearance of their vehicles but also add function and safety.

With the innovations of LED (Light Emitting Diode) technology, automotive owners now have new ways to personalize their vehicles while increasing safety. The addition of LED Lights to the rear of a vehicle improve safety by lighting up with a faster response time than traditional incandescent bulbs, therefore allowing more time for a vehicle to stop and avoid a rear-end collision. In U.S. Pat. No. 6,994,461 a lamp is disclosed that allows a vehicle owner to add LED technology to their existing automobile by replacing an incandescent bulbs with a bulb utilizing LEDs. However this lamp has the limitation of being installed only in the existing light housing that was utilized for the incandescent bulb. While this invention does provide added safety, it does not allow for installation of LED lighting outside of the existing housing.

What is needed is an LED Signal System that can accomplish the following: (i) mount on the rear of a truck at the base of or underneath the tailgate without impeding use of the tailgate. (ii) can be easily installed aftermarket without modification to the design of the truck. (iii) incorporates LEDs to provide indicators of brake lights and directional signals, and uses a different color of LEDs to provide indicators for reverse lights as well.

### SUMMARY OF THE INVENTION

It is therefore an object of the invention to provide an LED Signal System that can be easily mounted at the base of or underneath the tailgate of a truck.

It is another object of the invention to provide an LED Signal System that incorporates one or more LED lamps for brake and directional signal indicators and also includes one or more LED lamps that are a different color as an indicator for reverse lights.

In accord with these objects, which will be discussed in detail, this invention takes advantage of an area between the tailgate and bumper of a truck that was not previously considered an advantage for lighting. The LED Signal System includes a plurality of LED lights mounted in a housing and electrically connected to the truck via a standard trailer hitch adapter or connected directly to the existing wires in the truck that provide indications of turn signals, brake light, and reverse light.

### BRIEF DESCRIPTION OF THE DRAWINGS

A fuller understanding of the nature and objects of the present invention will become apparent upon consideration of the following detailed description, taken in connection with the accompanying drawings, wherein:

FIG. 1 is a side view of an embodiment of an LED Signal System

FIG. 2 is a front view of an embodiment of an LED Signal System

FIG. 3 is a rear view of a truck showing the LED Signal System installed.

### DETAILED DESCRIPTION OF THE PREFERRED EMBODIMENTS

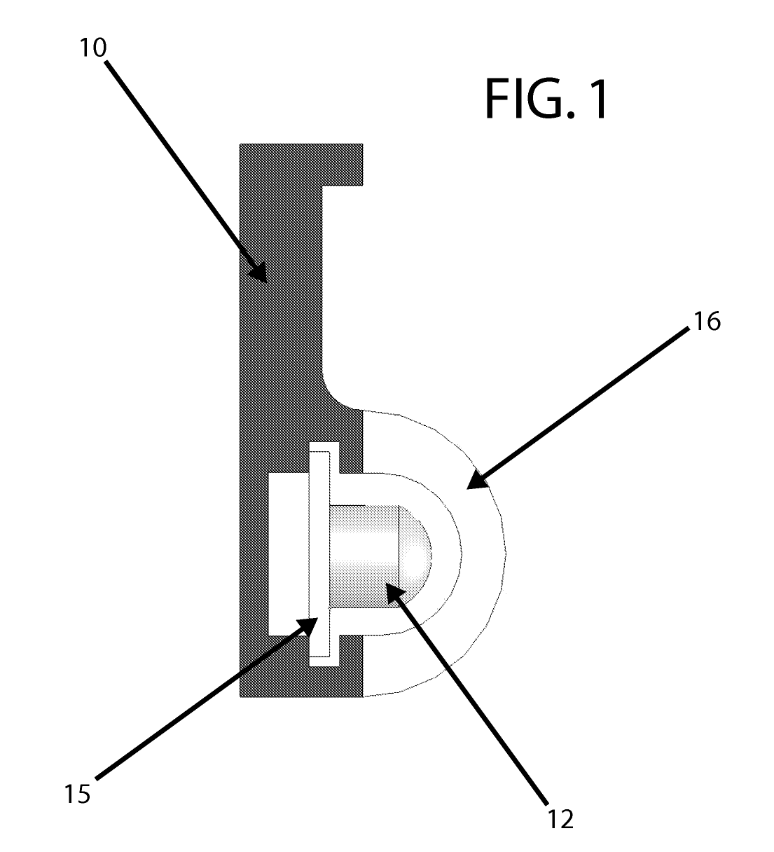

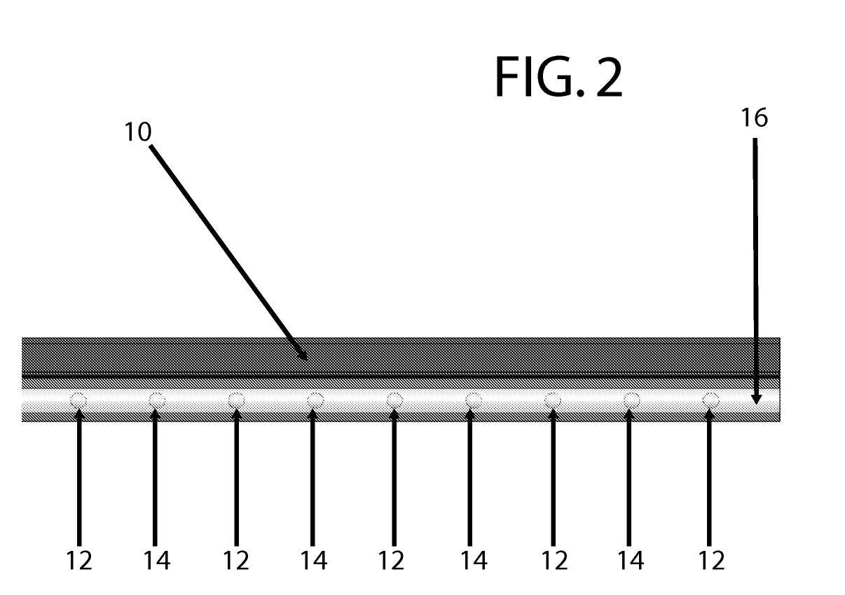

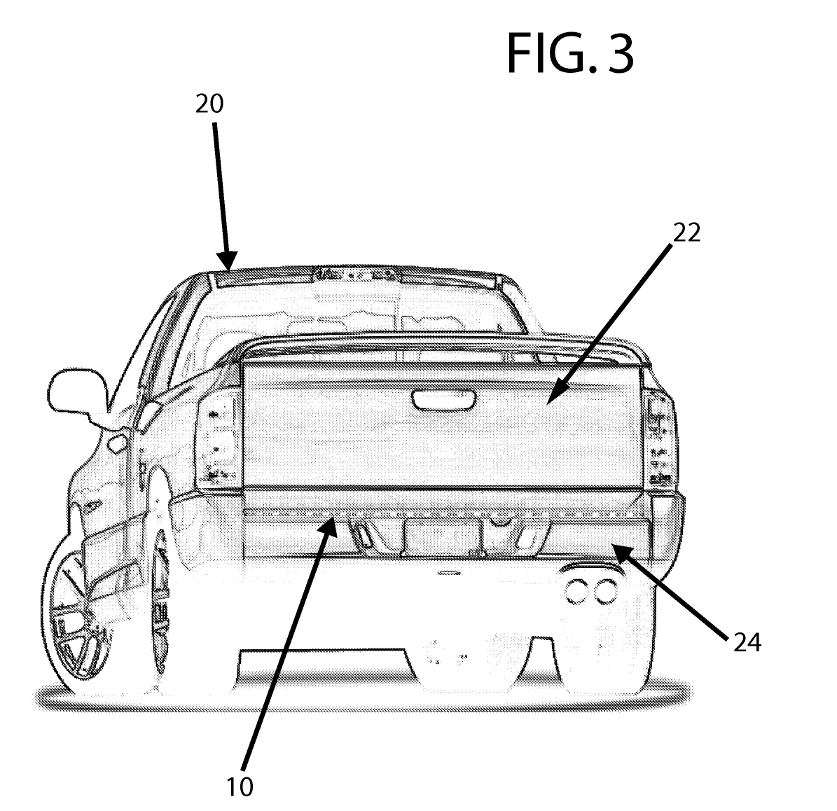

Referring to the drawings in FIG. 1 and FIG. 2, of an embodiment of an LED Signal System 10 designed according to the invention. LED Signal System 10 includes a plurality of LED lamps 12 to indicate brakes and turn signals as well as a plurality of LED lamps to indicate reverse lights 14 mounted on a circuit board 15 which are both secured in a plastic housing 16. Referring to FIG. 3, the LED Signal System 10 is designed to be installed on a truck 20 having a tailgate 22 and bumper 24.

The LED Signal System 10 is preferably wired by plugging to the trailer hitch plug receiver found on most trucks. Alternatively if a trailer hitch plug receiver is not found on the truck, the wires can be spliced in with the existing indication wires that power the brake, turn signal, and reverse lights on the truck.

According to a preferred aspect of the invention and referring to FIG. 3, the plastic housing 16 is sized in such a way that it does not interfere with the operation of lowering the tailgate 22 when installed on the truck 20. By installing the LED Signal System 10 in the space between the tailgate 22 and bumper 24, it is protected from weather and accidental damage while still being able to be viewed from the rear of the truck.

Different mechanisms for mounting the LED Signal System 10 to the truck 20 may be utilized. For example, the LED Signal System 10 may be directly attached using screws, bolts, hook and loop tape, bonding agents, adhesive foam tape, or magnets.

While a particular embodiment of the invention has been described, it is not intended that the invention be limited thereto. Thus, while a plurality of lamps are shown, it is understood that there may be fewer or more lamps. It is also understood that the lamps may be wired together in series or in parallel. However, it is preferable that the LED Signal System be provided with an array of LED lamps and that the lamps be wired in a way that if one LED lamp fails the remainder of the LED lamps may still be illuminated.

What is claimed is:

1. An LED Signal System for a truck comprising:
(a) a plurality of LED Lamps mounted on the bottom of the tailgate or in the space between the tailgate and the bumper to indicate the reverse light function of the truck.

2. An LED Signal System according to claim 1 wherein:
said plurality of lamps are mounted on a circuit board in a protective plastic housing.

3. An LED Signal System according to claim 1 wherein:
said plurality of lamps are connected electrically to the truck through a trailer hitch wiring receiver.

4. An LED Signal System according to claim 1 wherein:
said plurality of lamps are connected electrically to the truck by splicing wires directly into the truck's electrical system.

5. An LED Signal System according to claim 1, further comprising:
(b) mounting means for mounting said plurality of lamps to the truck.

6. An LED Signal System according to claim 1, further comprising:
(b) a plurality of LED Lamps mounted on the bottom of the tailgate or in the space between the tailgate and the bumper to indicate the brake light function of the truck.

7. An LED Signal System according to claim 1, further comprising:
(b) a plurality of LED Lamps mounted on the bottom of the tailgate or in the space between the tailgate and the bumper to indicate the turn signal function of the truck.
